(19) United States
(12) Patent Application Publication
(10) Pub. No.: US 2021/0149709 A1
(43) Pub. Date: May 20, 2021

(54) METHOD AND APPARATUS FOR PROCESSING TRANSACTION

(71) Applicant: BEIJING BAIDU NETCOM SCIENCE AND TECHNOLOGY CO., LTD., Beijing (CN)

(72) Inventors: Yi YANG, Beijing (CN); Ru YING, Beijing (CN)

(21) Appl. No.: 16/891,810

(22) Filed: Jun. 3, 2020

(30) Foreign Application Priority Data
Nov. 20, 2019 (CN) 201911142258.4

(51) Int. Cl. G06F 9/46; G06F 9/48; G06F 9/50; G06F 9/54; G06F 11/14; H04L 29/06

(52) U.S. Cl. CPC G06F 9/466; G06F 9/4843; G06F 9/505; G06F 2209/508; G06F 11/1474; H04L 67/42; G06F 9/542

(57) ABSTRACT

A method and apparatus for processing a transaction. A specific embodiment of the method includes: generating task information corresponding to the transaction processing request sent by a user terminal, the task information including operator information and operator dependency information, the operator information being used to represent at least one operation to be performed, and the operator dependency information being used to represent a dependency relationship between operations indicated by operators; and selecting, according to the operator dependency information, a piece of operator information as target operator information from the task information; sending the target operator information to a target agent; determining whether a task indicated by the task information is successfully executed based on a performing result of the target agent performing the operation indicated by the target operator information; and sending information representing whether the transaction processing request is successfully executed to the user terminal.

### CROSS-REFERENCE TO RELATED APPLICATIONS

This application claims priority to Chinese Patent Application No. 201911142258.4, filed with the China National Intellectual Property Administration (CNIPA) on Nov. 20, 2019, the contents of which are incorporated herein by reference in their entirety.

### TECHNICAL FIELD

Embodiments of the present disclosure relate to the field of computer technology, and specifically to a method and apparatus for processing a transaction.

### BACKGROUND

With the development of the Internet, cloud computing technology has been more and more widely used. In a cloud business scenario, a cloud resource operation request submitted by a user often requires a plurality of processing modules to cooperate to execute. In the entire process of processing the user operation, a restart or abnormality of any processing module on the task chain may affect the completion quality and data consistency of the operation request.

Related methods usually include using polling to trigger an execution node to run a command, and manage an executable package, for responding to a task request submitted by the user.

### SUMMARY

Embodiments of the present disclosure provide a method and apparatus for processing a transaction.

According to a first aspect, some embodiments of the present disclosure provide a method for processing a transaction, the method includes: generating, in response to receiving a transaction processing request sent by a user terminal, task information corresponding to the transaction processing request, the task information comprising operator information and operator dependency information, the operator information being used to represent at least one operation performed for processing a transaction indicated by the transaction processing request, and the operator dependency information being used to represent a dependency relationship between operations indicated by operators; and selecting, according to the dependency relationship indicated by the operator dependency information, a piece of operator information as target operator information from the task information, and performing following operator information-driven execution steps: sending the target operator information to a target agent, so that the target agent performs an operation indicated by the target operator information; determining whether a task indicated by the task information is successfully executed based on a performing result of the target agent performing the operation indicated by the target operator information; and sending information representing whether the transaction processing request is successfully executed to the user terminal.

In some embodiments, the method further includes: in response to determining that the task indicated by the task information is not successfully executed, performing a subsequent operation associated with the operation indicated by the target operator information, based on whether the operation indicated by the performing result of the target agent is successfully performed.

In some embodiments, the performing the subsequent operation associated with the operation indicated by the target operator information, based on whether the operation indicated by the performing result of the target agent is successfully performed, includes: in response to determining that the operation indicated by the performing result of the target agent is successfully performed, re-selecting, according to the dependency relationship indicated by the operator dependency information, a piece of operator information from the task information as new target operator information and continuing to perform the operator information-driven execution steps.

In some embodiments, the performing the subsequent operation associated with the operation indicated by the target operator information, based on whether the operation indicated by the performing result of the target agent is successfully performed, includes: in response to determining that the operation indicated by the performing result of the target agent is not successfully performed, acquiring rollback task information corresponding to the task information; and executing a rollback task indicated by the rollback task information.

In some embodiments, the sending the target operator information to a target agent, includes: selecting agent information having agent-type information matching the task information from a preset agent information set, to generate a quasi-target agent information set, wherein the agent information comprises agent-type information, and the agent-type information comprises at least one of: an identifier of a task namespace to which the agent-type information belongs or version information, and the task namespace corresponds to at least one type of the at least one operation performed for processing the transaction indicated by the transaction processing request; and determining the target agent from the quasi-target agent information set, based on a load balance condition.

In some embodiments, the task information comprises task directed acyclic graph information, the task directed acyclic graph information comprises node information and an edge expression, the operator information comprises the node information, the operator dependency information comprises the edge expression, and the edge expression comprises at least one of: a mandatory dependency relationship expression or a selective dependency relationship expression.

In some embodiments, the node information comprises isomorphic operator group information, and the isomorphic operator group information comprises a number of isomorphic operators in an isomorphic operator group represented by the isomorphic operator group information.

In some embodiments, the method further includes: using write-ahead logging for synchronization, based on a distributed protocol, in response to determining that the task indicated by the task information is successfully executed.

According to a second aspect, some embodiments of the present disclosure provide an apparatus for processing a transaction, the apparatus includes: a generation unit, configured to generate, in response to receiving a transaction processing request sent by a user terminal, task information corresponding to the transaction processing request, the task information comprising operator information and operator dependency information, the operator information being used to represent at least one operation performed for processing a transaction indicated by the transaction processing request, and the operator dependency information being used to represent a dependency relationship between operations indicated by operators; and a processing unit, configured to select, according to the dependency relationship indicated by the operator dependency information, a piece of operator information as target operator information from the task information, and perform following operator information-driven execution steps: sending the target operator information to a target agent, so that the target agent performs an operation indicated by the target operator information; determining whether a task indicated by the task information is successfully executed based on a performing result of the target agent performing the operation indicated by the target operator information; and sending information representing whether the transaction processing request is successfully executed to the user terminal.

In some embodiments, the apparatus further include: a performing unit, configured to perform, in response to determining that the task indicated by the task information is not successfully executed, a subsequent operation associated with the operation indicated by the target operator information, based on whether the operation indicated by the performing result of the target agent is successfully performed.

In some embodiments, the performing unit includes: a perform driving module, configured to re-select, according to the dependency relationship indicated by the operator dependency information, a piece of operator information from the task information as new target operator information and continue to perform the operator information-driven execution steps, in response to determining that the operation indicated by the performing result of the target agent is successfully performed.

In some embodiments, the performing unit includes: a task acquisition module, configured to acquire rollback task information corresponding to the task information, in response to determining that the operation indicated by the performing result of the target agent is not successfully performed; and an execution rollback module, configured to execute a rollback task indicated by the rollback task information.

In some embodiments, the performing unit is further configured to: select agent information having agent-type information matching the task information from a preset agent information set, to generate a quasi-target agent information set, wherein the agent information comprises agent-type information, and the agent-type information comprises at least one of: an identifier of a task namespace to which the agent-type information belongs or version information, and the task namespace corresponds to at least one type of the at least one operation performed for processing the transaction indicated by the transaction processing request; and determine the target agent from the quasi-target agent information set, based on a load balance condition.

In some embodiments, the task information comprises task directed acyclic graph information, the task directed acyclic graph information comprises node information and an edge expression, the operator information comprises the node information, the operator dependency information comprises the edge expression, and the edge expression comprises at least one of: a mandatory dependency relationship expression or a selective dependency relationship expression.

In some embodiments, the node information comprises isomorphic operator group information, and the isomorphic operator group information comprises a number of isomorphic operators in an isomorphic operator group represented by the isomorphic operator group information.

In some embodiments, the apparats further includes: a synchronization unit, configured to use write-ahead logging for synchronization, based on a distributed protocol, in response to determining that the task indicated by the task information is successfully executed.

According to a third aspect, some embodiments of the present disclosure provide a system for processing a transaction, the system includes: a user terminal, configured to send a transaction processing request to a server; a target agent, configured to receive operator information sent by the server, the operator information being used to represent at least one operation performed for processing a transaction indicated by the transaction processing request sent by the user terminal; perform the operation indicated by the operator information to generate a performing result; and send the performing result to the server; and the server, configured to perform the method according to any one of the implementations described in the present disclosure.

In some embodiments, the above target agent and the server use a heartbeat mechanism to renew a lease term, and a period corresponding a lease of the target agent matches a period corresponding to a lease of the server, to prevent misjudgment of a result of a detection on the target agent.

According to a fourth aspect, some embodiments of the present disclosure provide a server, the server includes: one or more processors; a storage apparatus, storing one or more programs thereon; and the one or more programs, when executed by the one or more processors, cause the one or processors to implement the method according to anyone of the implementations described in the present disclosure.

According to a fifth aspect, some embodiments of the present disclosure provide a computer readable medium, storing a computer program thereon, the program, when executed by a processor, implements the method according to any one of the implementations described in the present disclosure.

The method and apparatus for processing a transaction provided by the embodiments of the present disclosure, first, generating, in response to receiving a transaction processing request sent by a user terminal, task information corresponding to the transaction processing request, the task information including operator information and operator dependency information, the operator information being used to represent at least one operation performed for processing a transaction indicated by the transaction processing request, and the operator dependency information being used to represent a dependency relationship between operations indicated by operators, then selecting, according to the dependency relationship indicated by the operator dependency information, a piece of operator information as target operator information from the task information, according to the dependency relationship indicated by the operator dependency information, and performing the following operator information-driven execution steps: sending the target operator information to a target agent, so that the target agent performs an operation indicated by the target operator information; determining whether a task indicated by the task information is successfully executed based on a performing result of the target agent performing the operation indicated by the target operator information; and sending information representing whether the transaction processing request is successfully executed to the user terminal. Therefore, through the separation of task management mechanism and operation execution logic, not only the response speed of task management is improved, but also the user terminal is allowed to focus on the development of business logic without paying attention to complicated process management, thereby improving the iteration speed of product or service.

### BRIEF DESCRIPTION OF THE DRAWINGS

By reading the detailed description of non-limiting embodiments with reference to the following accompanying drawings, other features, objectives and advantages of the present disclosure will become more apparent:

FIG. 1 is a diagram of an exemplary system architecture in which an embodiment of the present disclosure may be implemented;

FIG. 2 is a flowchart of a method for processing a transaction according to an embodiment of the present disclosure;

FIG. 3 is a schematic diagram of an application scenario of the method for processing a transaction according to an embodiment of the present disclosure;

FIG. 4 is a flowchart of the method for processing a transaction according to another embodiment of the present disclosure;

FIG. 5 is a schematic structural diagram of an apparatus for processing a transaction according to an embodiment of the present disclosure;

FIG. 6 is a sequence diagram of interaction between various devices for processing a transaction according to an embodiment of the present disclosure; and

FIG. 7 is a schematic structural diagram of an electronic device adapted to implement the embodiments of the present disclosure.

### DETAILED DESCRIPTION OF EMBODIMENTS

Embodiments of present disclosure will be described below in detail with reference to the accompanying drawings. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present disclosure and some features in the disclosure may be combined with each other on a non-conflict basis. Features of the present disclosure will be described below in detail with reference to the accompanying drawings and in combination with embodiments.

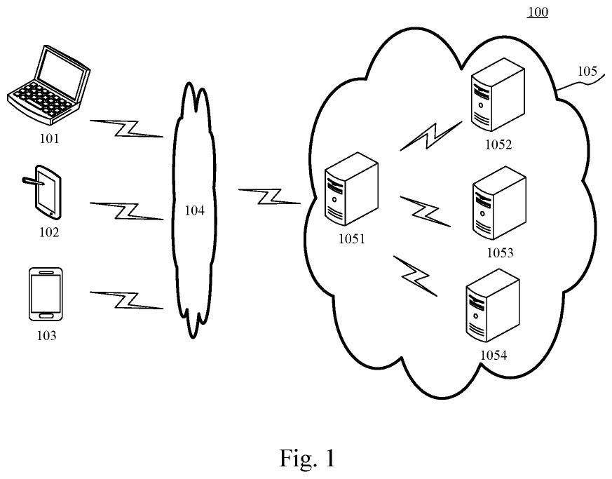

FIG. 1 illustrates an exemplary system architecture 100 in which a method for processing a transaction or an apparatus for processing a transaction of the present disclosure may be implemented.

As shown in FIG. 1, the system architecture 100 may include terminal devices 101, 102, 103, a network 104, and a server cluster 105. The network 104 is used to provide a communication link medium between the terminal devices 101, 102, 103 and the server cluster 105. The network 104 may include various types of connections, such as wired, wireless communication links, or optic fibers.

The terminal devices 101, 102, and 103 interact with the server cluster 105 through the network 104 to receive or send messages, and the like. Various communication client applications, such as web browser applications, shopping applications, search applications, instant messaging tools, mailbox clients, social platform software, or software development tools, may be installed on the terminal devices 101, 102, and 103.

The terminal devices 101, 102, and 103 may be hardware or software. When the terminal devices 101, 102, and 103 are hardware, they may be various electronic devices having display screens and supporting cloud resource operations, including but not limited to smart phones, tablet computers, e-book readers, laptop portable computers, desktop computers, or the like. When the terminal devices 101, 102, and 103 are software, they may be installed in the electronic devices listed above. It may be implemented as a plurality of software or software modules (for example, software or software modules used to provide distributed services), or as a single software or software module, which is not specifically limited herein.

The server cluster 105 may include servers that provide various services, such as a backend server that provides responses to cloud resource operation requests of the terminal devices 101, 102, and 103. The backend server may adopt a server-agent architecture. The server cluster 105 may include a server 1051, and agents 1052, 1053, and 1054. The server 1051 in the backend server cluster 105 may divide a cloud resource operation request into several sub-operations, and distribute the sub-operations to the agents 1052, 1053, 1054 for execution, and finally generate processing results based on the execution results (such as response information indicating success of data writing) and feed back the processing results to the terminal devices.

It should be noted that the server and the agent may be hardware or software. When the server, the agent is hardware, it may be implemented as a distributed server cluster composed of a plurality of servers or as a single server. When the server, the agent is software, it may be implemented as a plurality of software or software modules (for example, software or software modules used to provide distributed services) or as a single software or software module, which is not specifically limited herein. Alternatively, the agent may also run in the terminal devices 101, 102, and 103.

It should be noted that the method for processing a transaction provided by the embodiments of the present disclosure is generally performed by the server 1051. Correspondingly, the apparatus for processing a transaction is generally provided in the server 1051.

It should be understood that the number of terminal devices, networks, and servers, agents in FIG. 1 is merely illustrative. Depending on the implementation needs, there may be any number of terminal devices, networks, servers and agents.

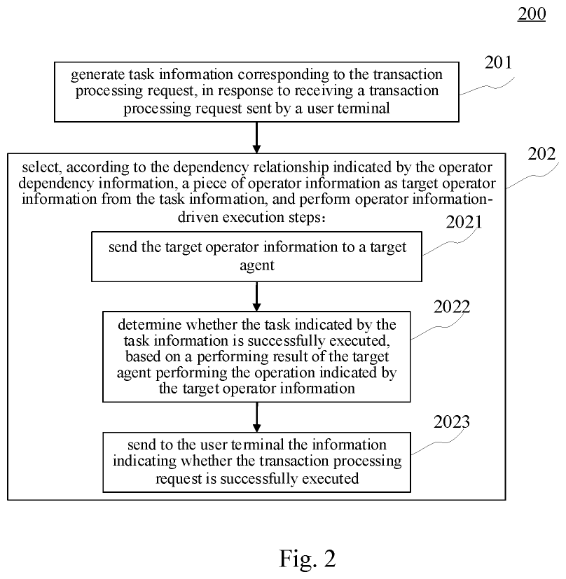

With further reference to FIG. 2, a flow 200 of a method for processing a transaction according to an embodiment of the present disclosure is illustrated. The method for processing a transaction includes the following steps:

Step 201, generating, in response to receiving a transaction processing request sent by a user terminal, task information corresponding to the transaction processing request.

In the present embodiment, in response to receiving the transaction processing request sent by the user terminal, an executing body of the method for processing a transaction (for example, the server 1051 shown in FIG. 1) may generate the task information corresponding to the transaction processing request using various methods. Generally, one time data operation request from a user may be regarded as a transaction processing request. The transaction processing request may generally correspond to a series of operations that need to be performed to realize the above transaction processing. The operations may include functions and parameters required by the functions. For example, the above corresponding relationship may be preset by those skilled in the art or the user terminal.

In the present embodiment, the executing body may generate the task information corresponding to the transaction processing request based on the transaction processing request sent by the user terminal. The task information may include operator information and operator dependency information. The operator information may be used to represent at least one operation performed for processing the transaction indicated by the transaction processing request. The operator information may include operator meta data, execution context and execution result. The operator meta data may include, but is not limited to, at least one of the following: an identifier of the project to which the operator belongs, name of the operator, identifier (id) of the operator, or version of the operator. The operator dependency information may be used to represent a dependency relationship between operations indicated by the operators, that is, a downstream operator determines, based on the dependency relationship, whether an operation condition is satisfied. The dependency relationship may include data and/or process dependency relationship. The dependency relationship may include, for example, but not limited to, at least one of the following: a mandatory dependency relationship or a selective dependency relationship. The mandatory dependency relationship may be used to represent that a downstream node may only be executed after the execution of an upstream node ends and succeeds. It can be seen that the mandatory dependency relationship is usually the key process in the task. The selective dependency relationship may be used to represent that a downstream node can be executed when the execution of an upstream node ends, regardless of whether the execution succeeds or fails. It can be seen that the execution failure of some node (such as upstream node) in the selective dependency relationship usually does not affect the execution and final result of the entire task, thereby providing a feasible solution for a downgrade processing of the corresponding business.

In some alternative implementations of the present embodiment, in response to receiving the transaction processing request sent by the user terminal, the executing body may also send information representing that the transaction processing request has been recorded to the user terminal. Therefore, the executing body may asynchronously process the received transaction processing request after feeding back the information to the user terminal.

In some alternative implementations of the present embodiment, the task information may include task directed acyclic graph information. The task directed acyclic graph information may include node information and an edge expression. The operator information may include the node information. The operator dependency information may include the edge expression. The edge expression may include, but is not limited to, at least one of the following: a mandatory dependency expression (such as the and expression), or a selective dependency expression (such as the or expression). Therefore, various operations in the task information and the dependency relationships between the operations may be graphically represented.

Based on the above alternative implementations, alternatively, the node information may include isomorphic operator group information. The isomorphic operator group information may include the number of isomorphic operators in an isomorphic operator group represented by the isomorphic operator group information. The isomorphic operators may be used to represent sibling nodes of the same type of operation. For example, a plurality of operators used to represent an acquisition operation that needs to be performed repeatedly may be used as the isomorphic operators. Alternatively, the isomorphic operator group information may further include meta data of the isomorphic operator group, and an upstream dependency relationship of the isomorphic operator group. Alternatively, the operator information of the isomorphic operators in the isomorphic operator group information may further include an index identifier for representing the relative position of an operator in the isomorphic operator group to which the operator belongs.

Based on the above alternative implementations, in the case of a complicated task structure and a large number of operators, the DAG structure is simplified by combining and representing the isomorphic operators as an operator group, therefore, there is no need to expand all the operators in the task information, which avoids a complicated DAG construction process, thereby facilitating user terminal access and task process presentation, and improving the efficiency of task management.

Step 202, selecting, according to the dependency relationship indicated by the operator dependency information, a piece of operator information as target operator information from the task information, and performing operator information-driven execution steps.

In the present embodiment, according to the dependency relationship indicated by the operator dependency information, the executing body may select a piece of operator information as the target operator information from the task information using various methods. For example, the executing body may first use operators at the most upstream of the operator dependency relationship as the operators to be selected. Then, an operator may be randomly selected from the operators to be selected, and operator information of the selected operator may be used as the target operator information. Then, the executing body may continue to perform the following operator information-driven execution steps.

In the present embodiment, the above operator information-driven execution steps may include steps 2021, 2022, and 2023.

Step 2021, sending the target operator information to a target agent.

In the present embodiment, the executing body may send the target operator information to the target agent through a wired or wireless connection, so that the target agent performs the operation indicated by the target operator information. The above target agent may be any agent specified in advance according to actual application needs. The target agent may also be an agent determined according to rules, for example, an agent determined according to a load balance strategy.

In some alternative implementations of the present embodiment, the executing body may also send the target operator information to the target agent through the following steps:

The first step, selecting agent information having agent-type information matching the task information from a preset agent information set, to generate a quasi-target agent information set.

In these alternative implementations, the executing body may select the agent information having the agent-type information matching the task information from the preset agent information set to generate the quasi-target agent information set by using various methods. The agent information may include agent-type information. The agent-type information may include at least one of the following: an identifier of a task namespace to which the agent-type information belongs, or version information. The task namespace may correspond to at least one type of the at least one operation performed for processing the transaction indicated by the transaction processing request.

Based on the above alternative implementations, the mechanism of matching the task namespace may support the parallel execution of operators, and at the same time may also support a hybrid deployment of a plurality of agents for different services, so that operators with an identical name in different task namespaces can also be properly executed. Moreover, the matching of the version information may realize the scheduling of a new version operator corresponding to a new version of the agent, thereby adapting to an incompatible upgrade of the agent.

The second step, determining the target agent from the quasi-target agent information set, based on a load balance condition.

Based on the above alternative implementations, the agent information in the quasi-target agent information set may further include load information of the agent. The executing body may determine the target agent from the quasi-target agent information set using a load balance strategy based on the load information of each agent in the quasi-target agent information set. The load balance strategy may include but is not limited to at least one of the following: RR (round-robin) simple polling, smooth weighted round-robin balancing, or hash-based distribution. Thus, the task throughput of the entire system may be improved.

Step 2022, determining whether a task indicated by the task information is successfully executed based on a performing result of the target agent performing the operation indicated by the target operator information.

In the present embodiment, based on the performing result of the target agent performing the operation indicated by the target operator information, the executing body may determine whether the task indicated by the task information is successfully executed using various methods. For example, the executing body may determine that the execution of the operation indicated by the target operator information is successful based on information fed back by the target agent for representing the successful execution of the operation indicated by the target operator information. Then, the executing body may determine whether the task indicated by the task information is successfully executed based on that the operation indicated by the above target operator information is the last operation in the task information. As yet another example, the executing body may determine that the target agent is down based on a condition such as that the target agent's heartbeat signal is not received within a preset time period, or information fed back by the target agent for representing a failure execution of the operation indicated by the target operator information is received, thereby determining that the task indicated by the task information is not successfully executed.

Step 2023, sending information representing whether the transaction processing request is successfully executed to the user terminal.

In the present embodiment, the executing body may send the information representing whether the transaction processing request is successfully executed to the user terminal using various methods. For example, the executing body may actively send the information representing whether the transaction processing request is successfully executed to the user terminal in a manner of notification. As yet another example, in response to receiving a transaction query request sent by the user terminal, the executing body may send response information representing whether the transaction processing request is successfully executed to the user terminal.

In some alternative implementations of the present embodiment, in response to determining that the task indicated by the task information is not successfully executed, the executing body may also perform a subsequent operation associated with the operation indicated by the target operator information, based on whether the operation indicated by the performing result of the target agent is successfully performed. The associated subsequent operation may include, but is not limited to, at least one of the following: an operator repeated callback processing, or resuming from breakpoint. The executing body and the target agent may use a heartbeat mechanism to renew a lease term. Alternatively, the executing body and other communication-connected agents may also use the heartbeat mechanism. Therefore, it is possible to prevent a misjudgment of a “live” status of an agent by appropriately setting the lengths of the periods corresponding to the respective leases of the executing body and the agent, thereby avoiding problems such as repeated execution or simultaneous execution by different agents of the operator.

Alternatively, in response to determining that the operation indicated by the performing result of the target agent is successfully performed, the executing body may re-select, according to the dependency relationship indicated by the operator dependency information, a piece of operator information from the task information as new target operator information and continue to perform the operator information-driven execution steps.

Alternatively, the executing body may further perform the following steps:

The first step, acquiring rollback task information corresponding to the task information, in response to determining that the operation indicated by the performing result of the target agent is not successfully performed.

In these implementations, in response to determining that the operation indicated by the performing result of the target agent is not successfully performed, the executing body may acquire the rollback task information corresponding to the task information. The rollback task information is used to indicate a rollback operation corresponding to the task information, which may be preset by the user terminal.

The second step, executing a rollback task indicated by the rollback task information.

In these implementations, the target agent may execute the rollback task indicated by the rollback task information. Thus, through the rollback of the task, resources generated by the operations that have been executed and completed during the task execution process are recycled to ensure the final consistency of data.

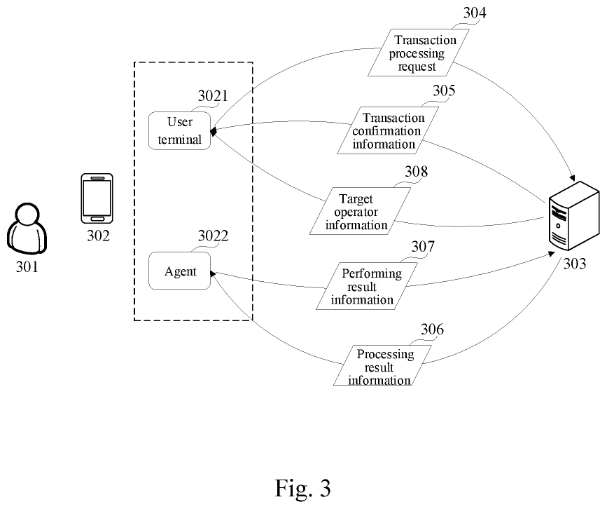

With further reference to FIG. 3, FIG. 3 is a schematic diagram of an application scenario of the method for processing a transaction according to an embodiment of the present disclosure. In the application scenario of FIG. 3, a user 301 writes data x to a file A through a terminal device 302. A client 3021 running on the terminal device 302 sends a transaction processing request 304 to a server 303 running on the server. The server 303 generates task information corresponding to the transaction processing request 304 and sends to the user terminal 3021 the transaction confirmation information 305 indicating that the above transaction processing request has been recorded. The server 303 then selects target operator information 306 from the task information, according to a dependency relationship indicated by an operator dependency information in the task information. Then, the server 303 sends the target operator information 306 to an agent 3022 running on the terminal device 302. Then, the agent 3022 feeds back execution result information 307 indicating successful execution to the server 303. The server 303 determines that the execution of the above task information is successful based on the execution result information 307, and sends processing result information 308 representing the success processing of the transaction to the user 3031 running on the terminal device 302. Thus, the user 301 may obtain the operation result through the terminal device 302.

At present, one of the existing technologies usually uses a polling method to trigger an execution node to run a command, which results in poor real-time character of the transaction processing. The method provided by the above embodiments of the present disclosure triggers generation of task information by receiving a transaction processing request, and uses an event-driven mechanism to improve the real-time character of the response. Moreover, by decomposing the task information into operator information and driving the agent for execution, the task management mechanism and the operation execution logic are separated. Therefore, on one hand, the response speed of task management is improved through service invocation rather than a script-oriented method. On the other hand, the user terminal may focus on the development of business logic without paying attention to complicated process management, thereby improving the iteration speed of product or service.

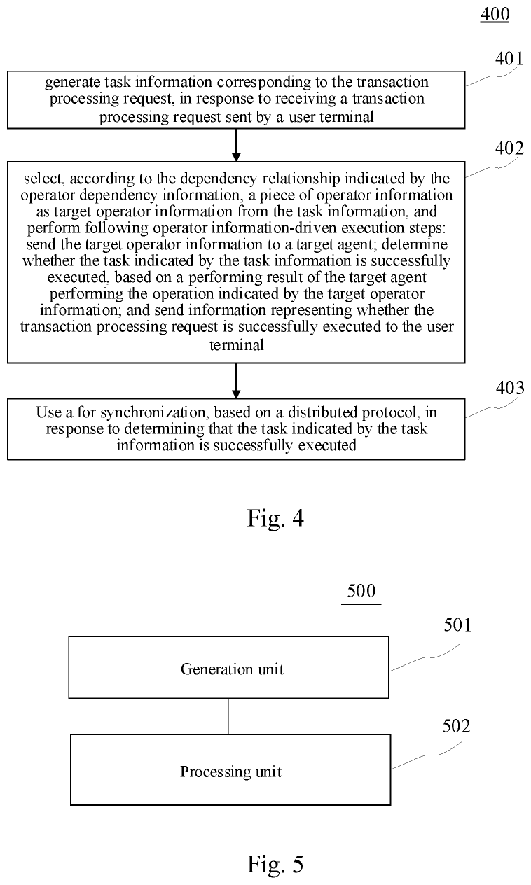

With further reference to FIG. 4, a flow 400 of another embodiment of the method for processing a transaction is illustrated. The flow 400 of the method for processing a transaction includes the following steps:

Step 401, generating, in response to receiving a transaction processing request sent by a user terminal, task information corresponding to the transaction processing request.

Step 402, selecting, according to the dependency relationship indicated by the operator dependency information, a piece of operator information as target operator information from the task information, and performing following operator information-driven execution steps: sending the target operator information to a target agent; determining whether a task indicated by the task information is successfully executed based on a performing result of the target agent performing the operation indicated by the target operator information; and sending information representing whether the transaction processing request is successfully executed to the user terminal.

The above steps 401 and 402 are respectively consistent with steps 201, 202 and their alternative implementations in the foregoing embodiments. The above descriptions of step 201, step 202 and their alternative implementations are also applicable to step 401 and step 402, and detailed description thereof will be omitted.

Step 403, using a write-ahead logging for synchronization, based on a distributed protocol, in response to determining that the task indicated by the task information is successfully executed.

In the present embodiment, in response to determining that the task indicated by the task information is successfully executed, based on the distributed protocol, an executing body of the method for processing a transaction (for example, the server 1051 shown in FIG. 1) may use the write-ahead logging for synchronization. The distributed protocol may include but not limited to at least one of the following: Raft (Raplication And Fault Tolerant), Paxos, ZAB (Zookeeper Atomic Broadcast).

In some alternative implementations of the present embodiment, the executing body may also take regular snapshots of the data synchronized by write-ahead logging.

It can be seen from FIG. 4 that the flow 400 of the method for processing a transaction in the present embodiment embodies the step of using the write-ahead logging for synchronization based on a distributed protocol after successful task execution. Therefore, the solution described in the present embodiment may use the distributed protocol to ensure partition fault tolerance and data consistency of the service, and complete a meta data write operation through the write-ahead logging, thereby ensuring the reliability of the server and improving transaction processing speed.

With further reference to FIG. 5, as an implementation of the method shown in the above figures, some embodiments of the present disclosure provide an apparatus for processing a transaction, and the apparatus embodiment corresponds to the method embodiment as shown in FIG. 2, and the apparatus may be specifically applied to various electronic devices.

As shown in FIG. 5, an apparatus 500 for processing a transaction provided by the present embodiment includes: a generation unit 501 and a processing unit 502. The generation unit 501 is configured to generate, in response to receiving a transaction processing request sent by a user terminal, task information corresponding to the transaction processing request, the task information including operator information and operator dependency information, the operator information being used to represent at least one operation performed for processing a transaction indicated by the transaction processing request, and the operator dependency information being used to represent a dependency relationship between operations indicated by operators. The processing unit 502 is configured to select, according to the dependency relationship indicated by the operator dependency information, the operator information as target operator information from the task information, and perform following operator information-driven execution steps: sending the target operator information to a target agent, so that the target agent performs an operation indicated by the target operator information; determining whether a task indicated by the task information is successfully executed based on a performing result of the target agent performing the operation indicated by the target operator information; and sending information representing whether the transaction processing request is successfully executed to the user terminal.

In the present embodiment, in the apparatus 500 for processing a transaction: for specific processing and the technical effects of the generation unit 501 and the processing unit 502, reference may be made to the relevant descriptions of step 201 and step 202 in the embodiment corresponding to FIG. 2, and detailed description thereof will be omitted.

In some alternative implementations of the present embodiment, the apparatus 500 for processing a transaction may further include: a performing unit (not shown in the figure), configured to perform, in response to determining that the task indicated by the task information is not successfully executed, a subsequent operation associated with the operation indicated by the target operator information, based on whether the operation indicated by the performing result of the target agent is successfully performed.

In some alternative implementations of the present embodiment, the performing unit may include: a perform driving module (not shown in the figure), configured to re-select, according to the dependency relationship indicated by the operator dependency information, a piece of operator information from the task information as new target operator information and continue to perform the operator information-driven execution steps, in response to determining that the operation indicated by the performing result of the target agent is successfully performed.

In some alternative implementations of the present embodiment, the performing unit may include: a task acquisition module (not shown in the figure) and an execution rollback module (not shown in the figure). The task acquisition module may be configured to acquire rollback task information corresponding to the task information, in response to determining that the operation indicated by the performing result of the target agent is not successfully performed. The execution rollback module may be configured to execute a rollback task indicated by the rollback task information.

In some alternative implementations of the present embodiment, the performing unit may be further configured to: select agent information having agent-type information matching the task information from a preset agent information set, to generate a quasi-target agent information set, where the agent information includes agent-type information, and the agent-type information includes at least one of: an identifier of a task namespace to which the agent-type information belongs or version information, and the task namespace corresponds to at least one type of the at least one operation performed for processing the transaction indicated by the transaction processing request; and determine the target agent from the quasi-target agent information set, based on a load balance condition.

In some alternative implementations of the present embodiment, the task information may include task directed acyclic graph information. The task directed acyclic graph information may include node information and an edge expression. The operator information may include the node information. The operator dependency information may include the edge expression. The edge expression may include at least one of: a mandatory dependency relationship expression or a selective dependency relationship expression.

In some alternative implementations of the present embodiment, the node information may include isomorphic operator group information. The isomorphic operator group information may include the number of isomorphic operators in an isomorphic operator group represented by the isomorphic operator group information.

In some alternative implementations of the present embodiment, the apparatus 500 for processing a transaction may further include: a synchronization unit (not shown in the figure), configured to use a write-ahead logging for synchronization, based on a distributed protocol, in response to determining that the task indicated by the task information is successfully executed.

The apparatus for processing a transaction provided by the above embodiment of the present disclosure, first, the generation unit 501 generates task information corresponding to the transaction processing request in response to receiving a transaction processing request sent by a user terminal, the task information including operator information and operator dependency information, the operator information being used to represent at least one operation performed for processing a transaction indicated by the transaction processing request, and the operator dependency information being used to represent a dependency relationship between operations indicated by the operators. Then, the processing unit 502 selects, according to the dependency relationship indicated by the operator dependency information, a piece of operator information as target operator information from the task information. Then, the processing unit 502 performs the following operator information-driven execution steps: sending the target operator information to a target agent, so that the target agent performs the operation indicated by the target operator information; determining whether a task indicated by the task information is successfully executed based on a performing result of the target agent performing the operation indicated by the target operator information; and sending information representing whether the transaction processing request is successfully executed to the user terminal. Therefore, through the separation of task management mechanism and operation execution logic, not only the response speed of task management is improved, but also the user terminal is allowed to focus on the development of business logic without paying attention to complicated process management, thereby improving the iteration speed of product or service.

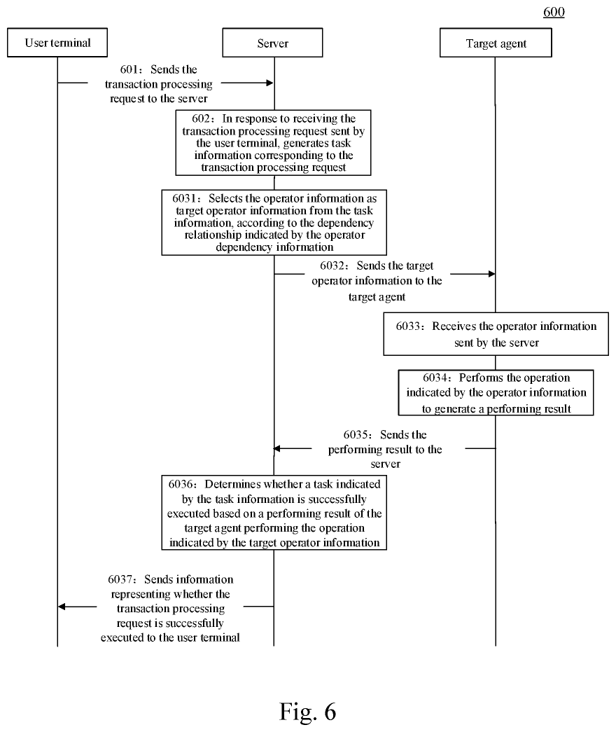

With further reference to FIG. 6, a sequence 600 of interactions between various devices in an embodiment of the method for processing a transaction is illustrated. The system for processing a transaction may include: a user terminal (for example, the terminal devices 101, 102, 103 shown in FIG. 1), a server (for example, the server 1051 shown in FIG. 1), and a target agent (for example, at least one of the servers 1052, 1053, and 1054 shown in FIG. 1). The user terminal may be configured to send a transaction processing request to a server. The server may be configured to implement the method for processing a transaction as described in the foregoing embodiments. The target agent may be configured to receive operator information sent by the server; perform the operation indicated by the operator information to generate a performing result; and send the performing result to the server. The operator information may be used to represent at least one operation performed by processing a transaction indicated by the transaction processing request sent by the user terminal.

In some alternative implementations of the present embodiment, the target agent and the server may use a heartbeat mechanism to renew a lease term. A period corresponding to a lease of the target agent may match a period corresponding to a lease of the server to prevent misjudgment of a detection result to the target agent.

As shown in FIG. 6, in step 601, the user terminal sends the transaction processing request to the server.

In the present embodiment, the user terminal may send the transaction processing request to the server through a wired or wireless connection. The transaction processing request may generally correspond to a series of operations that need to be performed to realize the above transaction processing. The operations may include functions and parameters required by the functions. For example, the above corresponding relationship may be preset by those skilled in the art or the user terminal.

Step 602, in response to receiving the transaction processing request sent by the user terminal, the server generates task information corresponding to the transaction processing request.

In step 6031, the server selects a piece of operator information as target operator information from the task information, according to the dependency relationship indicated by the operator dependency information.

In step 6032, the server sends the target operator information to the target agent.

In step 6033, the target agent receives the operator information sent by the server.

In step 6034, the target agent performs the operation indicated by the operator information to generate a performing result.

In the present embodiment, the operator information may include functions, parameters, etc. required to execute the operator. The target agent may execute the above operation logic based on the operator information, thereby generating the performing result.

In step 6035, the target agent sends the performing result to the server.

In the present embodiment, the target agent may send the performing result generated in step 6034 to the server through a wired or wireless connection.

In step 6036, the server determines whether a task indicated by the task information is successfully executed based on a performing result of the target agent performing the operation indicated by the target operator information.

In step 6037, the server sends information representing whether the transaction processing request is successfully executed to the user terminal.

The above steps 602 and 6031, 6032, 6036, 6037 are respectively consistent with the steps 201 and 202 and their alternative implementations in the foregoing embodiment. The above descriptions of step 201 and step 202 and their alternative implementations are also applicable to step 602 and steps 6031, 6032, 6036, 6037, and detailed description thereof will be omitted.

The system for processing a transaction provided by the above embodiment of the present disclosure, first, the user terminal sends the transaction processing request to the server. Then, in response to receiving the transaction processing request sent by the user terminal, the server generates task information corresponding to the transaction processing request. Then, the server selects, according to the dependency relationship indicated by the operator dependency information, a piece of operator information as target operator information from the task information. Next, the server sends the target operator information to the target agent. Then, the target agent receives the operator information sent by the server. After that, the target agent performs the operation indicated by the operator information to generate a performing result. Then, the target agent sends the performing result to the server. Then, the server determines whether a task indicated by the task information is successfully executed based on a performing result of the target agent performing the operation indicated by the target operator information. Finally, the server sends information representing whether the transaction processing request is successfully executed to the user terminal. Therefore, the task management mechanism and operation execution logic are executed separately by the server and the target agent, which not only improves the response speed of transaction processing request to the user terminal, but also allows the user terminal to focus on the development of business logic without paying attention to complicated process management, thereby improving the iteration speed of product or service.

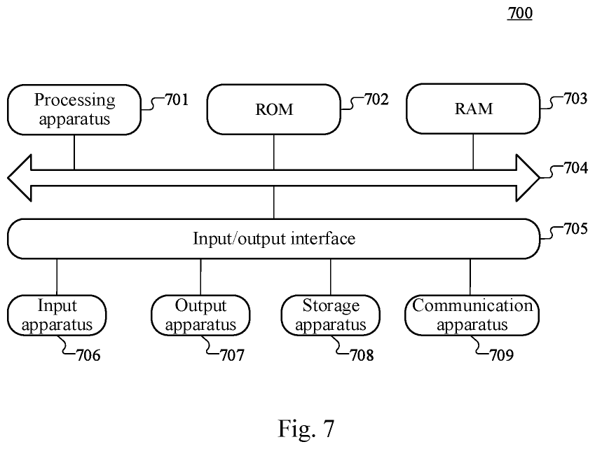

With further reference to FIG. 7, a schematic structural diagram of an electronic device (for example, the server 1051 in FIG. 1) 700 adapted to implement the embodiments of the present disclosure is illustrated. The server shown in FIG. 7 is merely an example and should not impose any limitation on the function and scope of use of the embodiments of the present disclosure.

As shown in FIG. 7, the electronic device 700 may include a processing apparatus (for example, a central processor, a graphics processor, etc.) 701, which may execute various appropriate actions and processes in accordance with a program stored in a read-only memory (ROM) 702 or a program loaded into a random access memory (RAM) 703 from a storage apparatus 708. The RAM 703 also stores various programs and data required by operations of the electronic device 700. The processing apparatus 701, the ROM 702 and the RAM 703 are connected to each other through a bus 704. An input/output (I/O) interface 705 is also connected to the bus 704.

Generally, the following apparatuses may be connected to the I/O interface 705: an input apparatus 706, including such as a touch screen, a touch pad, a keyboard, or a mouse; an output apparatus 707 including such as a liquid crystal display (LCD), a speaker, or a vibrator; the storage apparatus 708 including such as a magnetic tape, or a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all the apparatuses shown. More or fewer apparatuses may be implemented or provided instead. Each block shown in FIG. 7 may represent one apparatus, and may also represent a plurality of apparatuses as required.

In particular, according to some embodiments of the present disclosure, the process described above with reference to the flow chart may be implemented in a computer software program. For example, an embodiment of the present disclosure provides a computer program product, which comprises a computer program that is hosted in a machine-readable medium. The computer program comprises program codes for executing the method as illustrated in the flow chart. In such an embodiment, the computer program may be downloaded and installed from a network via the communication portion 709, or may be installed from the storage portion 708, or may be installed from the ROM 702. The computer program, when executed by the central processing unit (CPU) 701, implements the above mentioned functionalities as defined by the methods of the present disclosure.

It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. Amore specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In some embodiments of the present disclosure, the computer readable storage medium may be any tangible medium containing or storing programs which can be used by a command execution system, apparatus or element or incorporated thereto. In some embodiments of the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The computer readable medium may be included in the electronic device, or a stand-alone computer readable medium not assembled into the server. The computer readable medium carries one or more programs. The one or more programs, when executed by the server, cause the server to: generate, in response to receiving a transaction processing request sent by a user terminal, task information corresponding to the transaction processing request, the task information including operator information and operator dependency information, the operator information being used to represent at least one operation performed for processing a transaction indicated by the transaction processing request, and the operator dependency information being used to represent a dependency relationship between operations indicated by operators; and select, according to the dependency relationship indicated by the operator dependency information, a piece of operator information as target operator information from the task information, and perform following operator information-driven execution steps: sending the target operator information to a target agent, so that the target agent performs an operation indicated by the target operator information; determining whether a task indicated by the task information is successfully executed based on a performing result of the target agent performing the operation indicated by the target operator information; and sending information representing whether the transaction processing request is successfully executed to the user terminal.

A computer program code for executing operations in some embodiments of the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units involved in the embodiments of the present disclosure may be implemented by means of software or hardware. The described units may also be provided in a processor, for example, may be described as: a processor including a generation unit and a processing unit. Here, the names of these units do not in some cases constitute limitations to such units themselves. For example, the generation unit may also be described as “a unit configured to generate task information corresponding to the transaction processing request, in response to receiving a transaction processing request sent by a user terminal”.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the embodiments of the present disclosure are examples.

What is claimed is:

1. A method for processing a transaction, the method comprising:
generating, in response to receiving a transaction processing request sent by a user terminal, task information corresponding to the transaction processing request, the task information comprising operator information and operator dependency information, the operator information being used to represent at least one operation performed for processing a transaction indicated by the transaction processing request, and the operator dependency information being used to represent a dependency relationship between operations indicated by operators; and
selecting, according to the dependency relationship indicated by the operator dependency information, a piece of operator information as target operator information from the task information, and performing following operator information-driven execution steps: sending the target operator information to a target agent, so that the target agent performs an operation indicated by the target operator information; determining whether a task indicated by the task information is successfully executed based on a performing result of the target agent performing the operation indicated by the target operator information; and sending information representing whether the transaction processing request is successfully executed to the user terminal.

2. The method according to claim 1, wherein the method further comprises:
in response to determining that the task indicated by the task information is not successfully executed, performing a subsequent operation associated with the operation indicated by the target operator information, based on whether the operation indicated by the performing result of the target agent is successfully performed.

3. The method according to claim 2, wherein the performing the subsequent operation associated with the operation indicated by the target operator information, based on whether the operation indicated by the performing result of the target agent is successfully performed, comprises:
in response to determining that the operation indicated by the performing result of the target agent is successfully performed, re-selecting, according to the dependency relationship indicated by the operator dependency information, a piece of operator information from the task information as new target operator information and continuing to perform the operator information-driven execution steps.

4. The method according to claim 2, wherein the performing the subsequent operation associated with the operation indicated by the target operator information, based on whether the operation indicated by the performing result of the target agent is successfully performed, comprises:
in response to determining that the operation indicated by the performing result of the target agent is not successfully performed, acquiring rollback task information corresponding to the task information; and
executing a rollback task indicated by the rollback task information.

5. The method according to claim 1, wherein the sending the target operator information to a target agent, comprises:
selecting agent information having agent-type information matching the task information from a preset agent information set, to generate a quasi-target agent information set, wherein the agent information comprises agent-type information, and the agent-type information comprises at least one of: an identifier of a task namespace to which the agent-type information belongs or version information, and the task namespace corresponds to at least one type of the at least one operation performed for processing the transaction indicated by the transaction processing request; and
determining the target agent from the quasi-target agent information set, based on a load balance condition.

6. The method according to claim 1, wherein the task information comprises task directed acyclic graph information, the task directed acyclic graph information comprises node information and an edge expression, the operator information comprises the node information, the operator dependency information comprises the edge expression, and the edge expression comprises at least one of: a mandatory dependency relationship expression or a selective dependency relationship expression.

7. The method according to claim 6, wherein the node information comprises isomorphic operator group information, and the isomorphic operator group information comprises a number of isomorphic operators in an isomorphic operator group represented by the isomorphic operator group information.

8. The method according to claim 1, wherein the method further comprises:
using write-ahead logging for synchronization, based on a distributed protocol, in response to determining that the task indicated by the task information is successfully executed.

9. An apparatus for processing a transaction, the apparatus comprising:
at least one processor; and
a memory storing instructions, the instructions when executed by the at least one processor, cause the at least one processor to perform operations, the operations comprising:
generating, in response to receiving a transaction processing request sent by a user terminal, task information corresponding to the transaction processing request, the task information comprising operator information and operator dependency information, the operator information being used to represent at least one operation performed for processing a transaction indicated by the transaction processing request, and the operator dependency information being used to represent a dependency relationship between operations indicated by operators; and
selecting, according to the dependency relationship indicated by the operator dependency information, a piece of operator information as target operator information from the task information, and perform following operator information-driven execution steps: sending the target operator information to a target agent, so that the target agent performs an operation indicated by the target operator information; determining whether a task indicated by the task information is successfully executed based on a performing result of the target agent performing the operation indicated by the target operator information; and sending information representing whether the transaction processing request is successfully executed to the user terminal.

10. The apparatus according to claim 9, wherein the operations further comprise:
performing, in response to determining that the task indicated by the task information is not successfully executed, a subsequent operation associated with the operation indicated by the target operator information, based on whether the operation indicated by the performing result of the target agent is successfully performed.

11. The apparatus according to claim 10, wherein the performing the subsequent operation associated with the operation indicated by the target operator information, based on whether the operation indicated by the performing result of the target agent is successfully performed, comprises:
re-selecting, according to the dependency relationship indicated by the operator dependency information, a piece of operator information from the task information as new target operator information and continue to perform the operator information-driven execution steps, in response to determining that the operation indicated by the performing result of the target agent is successfully performed.

12. The apparatus according to claim 10, wherein the performing the subsequent operation associated with the operation indicated by the target operator information, based on whether the operation indicated by the performing result of the target agent is successfully performed, comprises:
acquiring rollback task information corresponding to the task information, in response to determining that the operation indicated by the performing result of the target agent is not successfully performed; and
executing a rollback task indicated by the rollback task information.

13. The apparatus according to claim 9, wherein the sending the target operator information to a target agent comprises:
selecting agent information having agent-type information matching the task information from a preset agent information set, to generate a quasi-target agent information set, wherein the agent information comprises agent-type information, and the agent-type information comprises at least one of: an identifier of a task namespace to which the agent-type information belongs or version information, and the task namespace corresponds to at least one type of the at least one operation performed for processing the transaction indicated by the transaction processing request; and
determining the target agent from the quasi-target agent information set, based on a load balance condition.

14. The apparatus according to claim 9, wherein the task information comprises task directed acyclic graph information, the task directed acyclic graph information comprises node information and an edge expression, the operator information comprises the node information, the operator dependency information comprises the edge expression, and the edge expression comprises at least one of: a mandatory dependency relationship expression or a selective dependency relationship expression.

15. The apparatus according to claim 14, wherein the node information comprises isomorphic operator group information, and the isomorphic operator group information comprises a number of isomorphic operators in an isomorphic operator group represented by the isomorphic operator group information.

16. The apparatus according to claim 9, wherein the operations further comprise:
using write-ahead logging for synchronization, based on a distributed protocol, in response to determining that the task indicated by the task information is successfully executed.

17. A system for processing a transaction, the system comprising:
a user terminal, configured to send a transaction processing request to a server;
a target agent, configured to receive operator information sent by the server, the operator information being used to represent at least one operation performed for processing a transaction indicated by the transaction processing request sent by the user terminal; perform the operation indicated by the operator information to generate a performing result; and send the performing result to the server; and
the server, configured to generate, in response to receiving a transaction processing request sent by a user terminal, task information corresponding to the transaction processing request, the task information comprising operator information and operator dependency information, the operator information being used to represent at least one operation performed for processing a transaction indicated by the transaction processing request, and the operator dependency information being used to represent a dependency relationship between operations indicated by operators; and select, according to the dependency relationship indicated by the operator dependency information, a piece of operator information as target operator information from the task information, and performing following operator information-driven execution steps: sending the target operator information to a target agent, so that the target agent performs an operation indicated by the target operator information; determining whether a task indicated by the task information is successfully executed based on a performing result of the target agent performing the operation indicated by the target operator information; and sending information representing whether the transaction processing request is successfully executed to the user terminal.

18. The system according to claim 17, wherein the target agent and the server use a heartbeat mechanism to renew a lease term, and a period corresponding a lease of the target agent matches a period corresponding to a lease of the server, to prevent misjudgment of a result of a detection on the target agent.

19. The system according to claim 17, wherein the server is further configured to: perform, in response to determining that the task indicated by the task information is not successfully executed, a subsequent operation associated with the operation indicated by the target operator information, based on whether the operation indicated by the performing result of the target agent is successfully performed.

20. A non-transitory computer readable medium, storing a computer program thereon, wherein the program, when executed by a processor, cause the processor to implement the method according to claim 1.
